(19) United States
(12) Patent Application Publication
(10) Pub. No.: US 2025/0346493 A1
(43) Pub. Date: Nov. 13, 2025

(54) ASYMMETRICAL OUT-OF-PLANE-ORDERED MULTICOMPONENT MAX PHASE AND MXENE, AND METHODS FOR MANUFACTURING THE SAME

(71) Applicant: Korea Advanced Institute of Science and Technology, Daejeon (KR)

(72) Inventors: Hojin Ryu, Daejeon (KR); Minseok Lee, Daejeon (KR)

(73) Assignee: Korea Advanced Institute of Science and Technology, Daejeon (KR)

(21) Appl. No.: 18/830,804

(22) Filed: Sep. 11, 2024

(30) Foreign Application Priority Data
May 9, 2024 (KR) 10-2024-0061193

(51) Int. Cl. C01B 32/907

(52) U.S. Cl. CPC C01B 32/907; C01P 2002/20; C01P 2002/50; C01P 2002/72; C01P 2002/77

(57) ABSTRACT

A MAX phase has a layered structure of M(n+1)AXn including a plurality of transition metal layers (where n is a natural number, and n and n+1 represent a number of layers). M includes at least two transition metal elements. X includes nitrogen or carbon. A includes at least a first element and a second element, which are different from each other and selected from a Group 13 element, a Group 14 element, a Group 15 element, and a Group 16 element. A difference in atomic radii of the first element and the second element is greater than or equal to 0.1 Å. A first transition metal layer and a second transition metal layer corresponding to opposite outer layers among the transition metal layers have different compositions so that the MAX phase and a MXene obtained from the MAX phase have an asymmetrical out-of-plane-ordered structure.

### CROSS-REFERENCE TO RELATED APPLICATION

This application claims priority under 35 USC § 119 to Korean Patent Application No. 10-2024-0061193 filed on May 9, 2024 in the Korean Intellectual Property Office (KIPO), the entire disclosure of which is incorporated herein by reference.

### BACKGROUND

### 1. Field

Embodiments of the present disclosure relate to a MXene. More particularly, embodiments of the present disclosure relate to asymmetrical out-of-plane-ordered multicomponent MAX phases and MXenes, and methods for manufacturing the same.

### 2. Description of the Related Art

A MXene is a two-dimensional material having a general formula of M₍ₙ₊₁₎Xₙ derived from a three-dimensional MAX phase (M₍ₙ₊₁₎AXₙ) corresponding thereto, in which M is an early transition metal (Ti, V, Cr, Nb, Ta, Zr, and Mo), A includes a Group 13 element and a Group 14 element, and X is carbon or nitrogen.

The MXene may be obtained by etching the MAX phase to remove an M-A bond. The MXene is a new material that has a high specific surface area, high electrical conductivity, and unique optical characteristics, so that the MXene may be applied to various fields such as batteries, photocatalysts, sensors, environmental purification, and electromagnetic wave shielding. In order to control such characteristics of the MXene, a strategy of manufacturing the MXene by mixing various transition metals may be adopted, and, to this end, a stable solid-solution MAX phase, which is a precursor of the MXene, has been explored.

So far, MAX phases in various chemical ordering states have been explored. For example, as the MAX phases, a complete solid-solution MAX phase in which transition metals are evenly mixed according to an ordering state, an out-of-plane-ordered MAX phase in which ordering is performed such that metal compositions of a central transition metal layer and an outer transition metal layer are different from each other, and an in-plane-ordered MAX phase in which a unique ordering state is provided in each of transition metal layers have been explored.

Among these, unlike an existing MXene (Ti₃C₂), an out-of-plane-ordered MXene (e.g., Mo₂TiC₂) exhibits semiconductive characteristics so that the out-of-plane-ordered MXene may have a negative temperature resistance coefficient, and may be converted into a diamagnetic or paramagnetic material by tuning elements of a central atomic layer and elements of an outer atomic layer.

In a case of existing out-of-plane-ordered MAX phases or MXenes, two outer transition metal layers (M″) are symmetrically ordered based on a central transition metal layer (M′) in the form such as M″2M′AX2 or M″2M′2AX3.

### SUMMARY

One object of the invention is to provide asymmetrical out-of-plane-ordered MAX phase and MXene.

Another object of the invention is to provide a method for manufacturing the MAX and the MXene.

According to one embodiment of the present disclosure, a MAX phase has a layered structure of M(n+1)AXn including a plurality of transition metal layers (where n is a natural number, and n and n+1 represent a number of layers). M includes at least two transition metal elements. X includes nitrogen or carbon. A includes at least a first element and a second element, which are different from each other and selected from a Group 13 element, a Group 14 element, a Group 15 element, and a Group 16 element. A difference in atomic radii of the first element and the second element is greater than or equal to 0.1 Å. A first transition metal layer and a second transition metal layer corresponding to opposite outer layers among the transition metal layers have different compositions so that the MAX phase has an asymmetrical out-of-plane-ordered structure.

In one embodiment, the first element of A is Al, and the second element of A is Sn.

In one embodiment, a molar ratio of Al and Sn is 1.8:1 to 2.2:1.

In one embodiment, the MAX phase has the 312 phase.

In one embodiment, M includes at least three elements. An element with a highest content in the first transition metal layer is an element with a highest atomic number among the elements of M. An element with a highest content in the second transition metal layer is an element with a lowest atomic number among the elements of M.

In one embodiment, the transition metal layers further include a third transition metal layer disposed between the first transition metal layer and the second transition metal layer. M includes Ti, Zr, Hf, and Ta. An element with a highest content in the first transition metal layer is Ti. An element with a highest content in the second transition metal layer is Ta. An element with a highest content in the third transition metal layer is Hf.

In one embodiment, the transition metal layers further include a third transition metal layer disposed between the first transition metal layer and the second transition metal layer. M includes Ti, Zr, Hf, and Ta. Ti and Ta have a lowest content in the third transition metal layer. Zr and Hf have a lowest content in the second transition metal layer.

According to one embodiment of the present disclosure, a MXene has a layered structure of M₍ₙ₊₁)Xₙ including a plurality of transition metal layers (where n is a natural number, and n and n+1 represent a number of layers). M includes at least two transition metal elements. X includes nitrogen or carbon. A first transition metal layer and a second transition metal layer corresponding to opposite outer layers among the transition metal layers have different compositions so that the MXene has an asymmetrical out-of-plane-ordered structure.

According to one embodiment of the present disclosure, a method for manufacturing a MAX phase is provided. The method includes mixing and milling raw materials of an M component including at least two transition metal elements, an X component including nitrogen or carbon, and an A component including at least a first element and a second element, which are different from each other and selected from a Group 13 element, a Group 14 element, a Group 15 element, and a Group 16 element; and forming the MAX phase having a layered structure of M₍ₙ₊₁₎AXₙ (where n is a natural number, and n and n+1 represent a number of layers) including a plurality of transition metal layers by pressurizing and sintering powder obtained through the milling. A difference in atomic radii of the first element and the second element is greater than or equal to 0.1 Å. A first transition metal layer and a second transition metal layer corresponding to opposite outer layers among the transition metal layers have different compositions so that the MAX phase has an asymmetrical out-of-plane-ordered structure. A number of moles of the raw material of the A component is greater than or equal to a number of moles of the raw material of the M component.

According to one embodiment of the present disclosure, a method for manufacturing a MXene is provided. The method includes obtaining the MXene by removing an A component from the MAX phase.

As described above, according to exemplary embodiments of the present disclosure, a MAX phase and a MXene having an asymmetrical out-of-plane-ordered structure may be obtained. In addition, a composition of the MXene can be adjusted to have desired characteristics in application fields through fine tuning of each of transition metal layers.

In addition, the MXene having the structure described above can have semiconductive characteristics as well as excellent photocatalytic characteristics, thermoelectric characteristics, and piezoelectric effects. Therefore, the MXene can be used in various fields such as sensor fields using piezoelectric effects, biotechnologies, computers, and home appliances using thermoelectric elements, and eco-friendly power generation or hydrogen power generation using catalytic characteristics.

In addition, since semiconductive characteristics and magnetic characteristics of the MAX phase and the MXene, which have outer layers that are asymmetrically ordered, can be tuned, the MAX phase and the MXene can be applied to next-generation memories and advanced semiconductor fields, and particularly, compositions and structures of the MAX phase and the MXene can be adjusted to expectedly have topological insulator characteristics so that the MAX phase and the MXene can be used in quantum computer fields.

### BRIEF DESCRIPTION OF THE DRAWINGS

FIG. 1 is a schematic view showing a layered structure of a MAX phase and a MXene according to one embodiment of the present disclosure.

FIG. 2 is a flowchart for describing a method for manufacturing a MAX phase according to one embodiment of the present disclosure.

FIG. 3 shows an X-ray diffraction (XRD) analysis result of a MAX phase according to Example 1.

FIG. 4 is an enlarged image of a high-angle annular dark-field (HAADF)-transmission electron microscopy (TEM) photograph of the MAX phase according to Example 1.

FIG. 5 is a schematic view showing a large-box modeling result obtained based on an atomic pair distribution function (PDF) and an XRD measurement value of the MAX phase according to Example 1.

### DETAILED DESCRIPTION OF THE EMBODIMENTS

Various embodiments will be described more fully hereinafter with reference to the accompanying drawings, in which some embodiments are shown. The invention may, however, be embodied in many different forms and should not be construed as limited to the embodiments set forth herein. Rather, these embodiments are provided so that this description will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a,” “an” and “the” are intended to include a plurality of forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

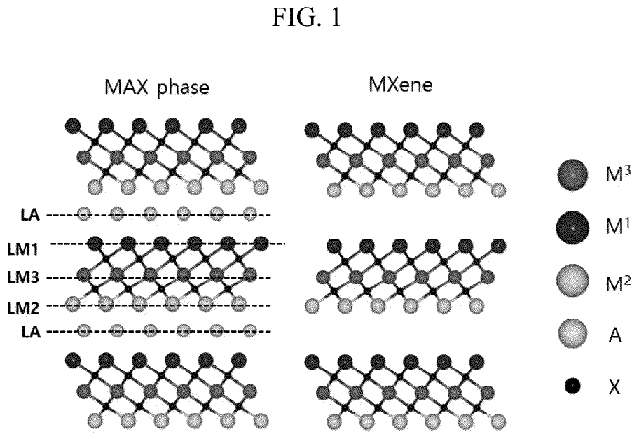

FIG. 1 is a schematic view showing a layered structure of a MAX phase and a MXene according to one embodiment of the present disclosure.

According to one embodiment of the present disclosure, a MAX phase may have a structure of M₍ₙ₊₁₎AXₙ (where n is a natural number, and n and n+1 represent the number of layers). M may be a transition metal (early transition metal), and may include at least two elements. For example, M may include at least two selected from Ti, V, Cr, Zr, Nb, Mo, Hf, and Ta. A may include at least two elements selected from a Group 13 element, a Group 14 element, a Group 15 element, and a Group 16 element. For example, A may include at least two elements selected from Al, Si, P, S, Ga, Ge, As, In, and Sn. The two elements included in A may have different atomic radii. For example, a difference in the atomic radii of the two elements included in A may be greater than or equal to 0.1 Å.

For example, A may include a first element, and a second element having a greater atomic radius than the first element. According to one embodiment, A may include Al and Sn. X may represent N or C.

Therefore, each of the MAX phase and the MXene may include at least two layers including M. Referring to FIG. 1, each of the MAX phase and the MXene may include three layers including M (transition metal), and two layers including X. For example, the MAX phase may include a first M layer LM1, a second M layer LM2, and a third M layer LM3. Each of the first M layer LM1 and the second M layer LM2 may correspond to an outer layer adjacent to an A layer LA, and the third M layer LM3 may correspond to an intermediate layer disposed between the first M layer LM1 and the second M layer LM2. Two X layers may be disposed between the first M layer LM1 and the third M layer LM3, and between the second M layer LM2 and the third M layer LM3, respectively. The MXene may be obtained by removing the A layer from the MAX phase.

According to one embodiment, a plurality of M layers of each of the MAX phase and the MXene may have different compositions. For example, the first M layer LM1 and the second M layer LM2 making contact with the A layer LA may have different compositions, so that an asymmetrical out-of-plane-ordered structure may be formed. Referring to FIG. 1, although the first M layer LM1 has been shown as including a first M element M¹, and the second M layer LM2 has been shown as including a second M element M² that is different from the first M element M¹, each of the M layers may not substantially include a single element, and the M layers may include a plurality of elements with different compositions.

For example, the first M layer LM1 may include the highest content of the first M element M¹, and the second M layer LM2 may include the highest content of the second M element M² that is different from the first M element M¹. The third M layer LM3 corresponding to the intermediate layer may include the highest content of a third M element M³, but embodiments are not limited thereto, and the third M layer LM3 may include the highest content of the first M element M¹ or the second M element M².

According to one embodiment, the first M element M¹ may be an element with a lowest atomic number among the elements included in M, and the second M element M² may be an element with a highest atomic number among the elements included in M.

As described above, the number of layers of M may be at least two, and M may include at least two elements, so that the embodiments of the present disclosure are not limited to the structure described above, and, when the M layers making contact with the A layer have different compositions, such a structure may be defined as an asymmetrical out-of-plane-ordered structure.

For example, M may include at least four different elements, and the number of layers of M may be three. Alternatively, M may include 2 to 4 different elements, and the number of layers of M may be at least five. In addition, M may include at least two different elements, and the number of layers of M may be two.

According to one embodiment, each of the MAX phase and the MXene may be configured such that the number of layers of M is three, M includes Ti, Zr, Hf, and Ta, and A includes Al and Sn. The A layer may have a solid-solution phase in which Al and Sn are mixed. When the MAX phase includes the first M layer and the second M layer, each of which corresponds to the outer layer adjacent to the A layer LA, and includes the third M layer corresponding to the intermediate layer, an element with the highest content in the first M layer may be Ti, an element with the highest content in the second M layer may be Ta, and an element with the highest content in the third M layer may be Hf. In addition, Ti and Ta may have the lowest content in the third M layer, and Zr and Hf may have the lowest content in the second M layer. In addition, Zr may have the highest content in the third M layer.

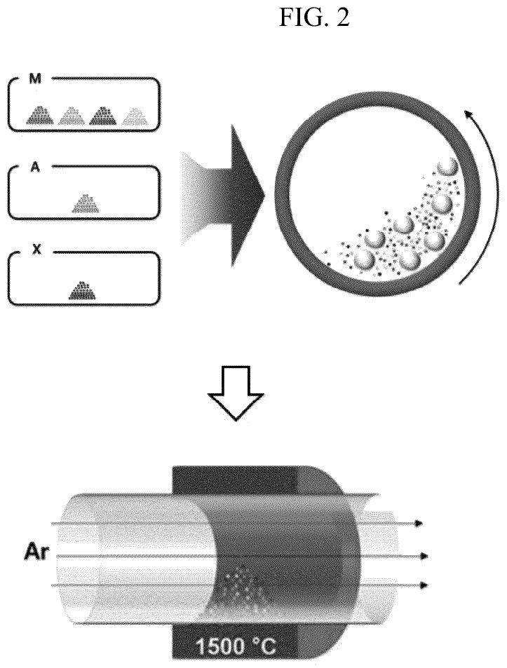

FIG. 2 is a flowchart for describing a method for manufacturing a MAX phase according to one embodiment of the present disclosure. Referring to FIG. 2, in order to obtain the MAX phase according to one embodiment of the present disclosure, ball milling may be used as in a general MAX phase. For example, the MAX phase may be obtained by mixing and ball-milling powder of element components, pelletizing powder obtained through the mixing and the ball milling, performing sintering in an inert gas atmosphere, and removing an intermetallic compound and a carbide impurity from a material obtained through the sintering by using a strong acid such as a hydrochloric acid. In addition, the MXene may be obtained by heating the MAX phase in molten salt at a high temperature, or treating the MAX phase with a hydrofluoric acid to remove the A layer.

According to one embodiment, upon the mixing of the elemental components, contents of an M component and a C component may be identical or similar to contents in a composition of the MXene to be obtained, an A component may be inserted with an excessive amount. The MAX phase and the A layer may tend to form a symmetrical structure at a high temperature (about 1,400° C.) or more at which the MAX phase is generally formed. However, A glue formed by melting the A component, which is inserted with an excessive amount, at a high temperature may serve as a solvent to substantially lower a formation temperature of the MAX phase or the A layer, so that an asymmetric structure may be formed.

According to one embodiment, when the number of transition metal layers is three, and a MAX phase of M₃AC₂ in which an A layer includes Al and Sn is obtained, a mixing molar ratio of M and Al may be 3:2.5 to 3:2.7. When Al is excessively small, an M₂AC impurity may be increased, and the formation temperature of the MAX phase may be substantially increased, so that a MAX phase having a symmetrical structure may be obtained. When the content of M including Al is excessively high, an intermetallic compound may be increased.

In addition, a mixing molar ratio of Al and Sn may be 1:0.15 to 1:0.25, for example, about 1:0.2. A mixing ratio of M and a total A component including Al and Sn may be 3:3 to 3:3.2. In other words, the number of moles of the A component may be greater than or equal to the number of moles of the M component. This is significantly higher than a quantitative range of each of the MAX phase and the MXene and a content of A conventionally used in manufacturing a MAX phase.

A molar ratio of Al and Sn in the A layer of each of the MAX phase and the MXene may be about 2:1. When an error range is taken into consideration, the molar ratio of Al and Sn may be 1.8:1 to 2.2:1.

The A layer having the solid-solution phase, which has the composition described above, may have distortion, which may result in differences in affinity, electronegativity, and the like. Accordingly, in order to form a stable structure of a generated MAX phase, an M layer (transition metal layer) adjacent to a top surface of the A layer and an M layer adjacent to a bottom surface of the A layer may have different compositions. Accordingly, the M layers adjacent to the A layers may be asymmetrically out-of-plane-ordered.

According to one embodiment, the MAX phase and the MXene obtained according to the configuration described above may have the 312 phase.

According to the embodiments of the present disclosure, a MAX phase and a MXene having an asymmetrical out-of-plane-ordered structure may be obtained. In addition, a composition of the MXene may be adjusted to have desired characteristics in application fields through fine tuning of each of transition metal layers.

In addition, the MXene having the structure described above may have semiconductive characteristics as well as excellent photocatalytic characteristics, thermoelectric characteristics, and piezoelectric effects. Therefore, the MXene may be used in various fields such as sensor fields using piezoelectric effects, biotechnologies, computers, and home appliances using thermoelectric elements, and eco-friendly power generation or hydrogen power generation using catalytic characteristics.

In addition, since semiconductive characteristics and magnetic characteristics of the MAX phase and the MXene, which have outer layers that are asymmetrically ordered, may be tuned, the MAX phase and the MXene may be applied to next-generation memories and advanced semiconductor fields, and particularly, compositions and structures of the MAX phase and the MXene may be adjusted to expectedly have topological insulator characteristics so that the MAX phase and the MXene may be used in quantum computer fields.

Hereinafter, manufacture and effects according to the present disclosure will be reviewed through a specific embodiment and an experimental example. The embodiment and the experimental example have been provided only for illustrative purposes, and the scope of the present disclosure is not limited to the content provided in the experimental example.

### Example 1

Ti, Zr, Hf, Ta, Al, Sn, and C powder were mixed at a ratio of 0.75:0.75:0.75:0.75:2.6:0.52:1.8, and milling was performed for a total of 10 hours such that milling is performed for 10 minutes by using 100 g of zirconia balls having a diameter of 5 mm (ball-to-powder ratio=5:1), and cooling is performed for 5 minutes.

Next, 3 g of powder obtained through the milling was inserted into an 8 mm steel mold, and a pressure of 100 MPa was applied to generate green pellets. The green pellets were inserted into alumina glass, and normal-pressure sintering was performed at 1,500° C. in an argon atmosphere for 4 hours (temperature increase rate: 3° C./min).

A MAX phase was obtained by pulverizing and sieving the pellets obtained through sintering, and reacting the pellets in HCl for 18 hours or more to remove an intermetallic compound impurity (ZrAl₃, etc.).

As a result of analyzing the obtained MAX phase through energy-dispersive X-ray spectroscopy (EDS), a composition of the MAX phase was found to be (Ti_{0.818}Zr_{0.545}Hf_{0.818}Ta_{0.818})₃(Al_{0.66}Sn_{0.33})C₂ (=(Ti_{3/11}Zr_{2/11}Hf_{3/11}Ta_{3/11})₃(Al_{2/3}Sn_{1/3})C₂).

A MXene was obtained by inserting the MAX phase into molten salt including CuCl₂—KCl—NaCl, and heating the MAX phase to 750° C. to etch an A layer (Al, Sn).

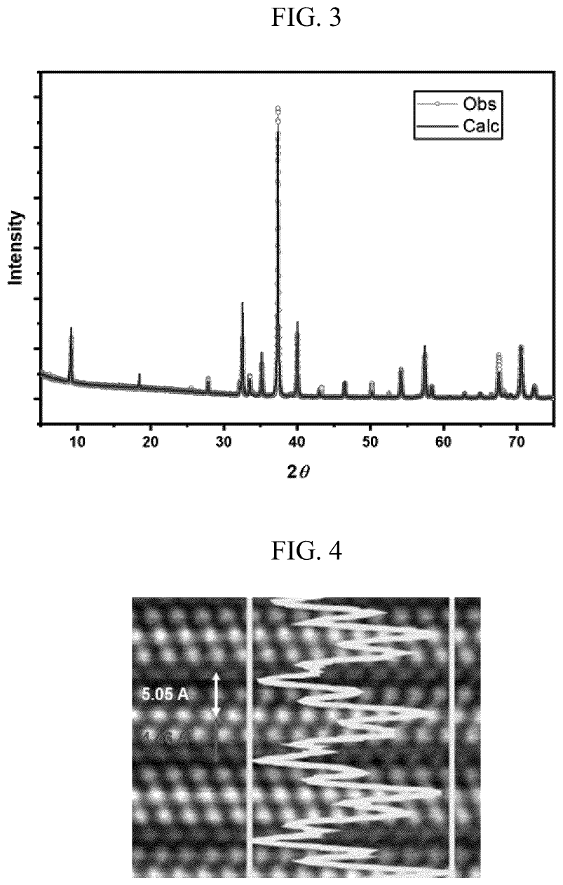

FIG. 3 shows an X-ray diffraction (XRD) analysis result of a MAX phase according to Example 1. Obs is a measured value, and Calc is a calculated value of a MAX phase having a symmetrical out-of-plane-ordered structure, which is expected through the composition.

Referring to FIG. 3, unlike an expected result, a (004) peak did not exist, and a (006) peak was observed. Accordingly, the MAX phase according to Example 1 did not have a symmetrical out-of-plane-ordered structure.

FIG. 4 is an enlarged image of a high-angle annular dark-field (HAADF)-transmission electron microscopy (TEM) photograph of the MAX phase according to Example 1.

Referring to FIG. 4, the MAX phase according to Example 1 included three transition metal layers, and distances from an intermediate layer to A layers on both sides were different from each other. Accordingly, the MAX phase according to Example 1 had an asymmetrical out-of-plane-ordered structure.

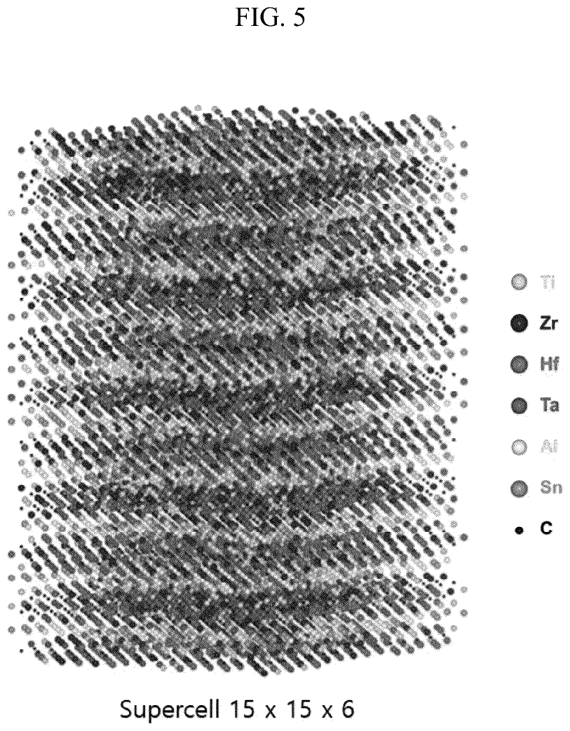

In order to track the composition of the MAX phase according to Example 1, large-box modeling for refining the structure was performed by fitting an atomic pair distribution function (PDF) and an XRD measurement value through reverse Monte Carlo simulation. FIG. 5 is a schematic view showing a large-box modeling result obtained based on an atomic pair distribution function (PDF) and an XRD measurement value of the MAX phase according to Example 1.

The structure determined through the large-box modeling in FIG. 5 was analyzed to show an element ratio of each of transition metal layers in Table 1 below.

TABLE 1

| M-site | Ti | Zr | Hf | Ta |
|---|---|---|---|---|
| M¹ | 44.8 | 25.9 | 13.9 | 15.3 |
| M³ | 0 | 28.4 | 64.2 | 7.3 |
| M² | 36 | 1.1 | 2.8 | 60.3 |

Referring to Table 1, when the MAX phase according to Example 1 includes a first M layer (M¹) and a second M layer (M²), each of which corresponds to an outer layer adjacent to an A layer, and includes a third M layer (M³) corresponding to an intermediate layer, an element with the highest content in the first M layer was Ti, an element with the highest content in the second M layer was Ta, and an element with the highest content in the third M layer was Hf. In addition, Ti and Ta had the lowest content in the third M layer, Zr and Hf had the lowest content in the second M layer, and Zr had the highest content in the third M layer.

Although exemplary embodiments of the present disclosure have been described above, it will be understood by a person having ordinary skill in the art that various modifications and changes can be made to the present disclosure without departing from the idea and scope of the present disclosure as set forth in the appended claims.

Embodiments of the present disclosure may be used in various fields such as sensor fields using piezoelectric effects, biotechnologies, computers, and home appliances using thermoelectric elements, eco-friendly power generation or hydrogen power generation using catalytic characteristics, and semiconductor fields using semiconductor characteristics.

What is claimed is:

1. A MAX phase, wherein the MAX phase has a layered structure of M₍ₙ₊₁₎AXₙ including a plurality of transition metal layers (where n is a natural number, and n and n+1 represent a number of layers),
M includes at least two transition metal elements,
X includes nitrogen or carbon,
A includes at least a first element and a second element, which are different from each other and selected from a Group 13 element, a Group 14 element, a Group 15 element, and a Group 16 element,
a difference in atomic radii of the first element and the second element is greater than or equal to 0.1 Å, and
a first transition metal layer and a second transition metal layer corresponding to opposite outer layers among the transition metal layers have different compositions so that the MAX phase has an asymmetrical out-of-plane-ordered structure.

2. The MAX phase of claim 1, wherein the first element of A is Al, and
the second element of A is Sn.

3. The MAX phase of claim 2, wherein a molar ratio of Al and Sn is 1.8:1 to 2.2:1.

4. The MAX phase of claim 1, wherein the MAX phase has the 312 phase.

5. The MAX phase of claim 1, wherein M includes at least three elements,
an element with a highest content in the first transition metal layer is an element with a highest atomic number among the elements of M, and
an element with a highest content in the second transition metal layer is an element with a lowest atomic number among the elements of M.

6. The MAX phase of claim 1, wherein the transition metal layers further include a third transition metal layer disposed between the first transition metal layer and the second transition metal layer,
M includes Ti, Zr, Hf, and Ta,
an element with a highest content in the first transition metal layer is Ti,
an element with a highest content in the second transition metal layer is Ta, and
an element with a highest content in the third transition metal layer is Hf.

7. The MAX phase of claim 1, wherein the transition metal layers further include a third transition metal layer disposed between the first transition metal layer and the second transition metal layer,
M includes Ti, Zr, Hf, and Ta,
Ti and Ta have a lowest content in the third transition metal layer, and
Zr and Hf have a lowest content in the second transition metal layer.

8. A MXene, wherein the MXene has a layered structure of M₍ₙ₊₁₎Xₙ including a plurality of transition metal layers (where n is a natural number, and n and n+1 represent a number of layers),
M includes at least two transition metal elements,
X includes nitrogen or carbon, and
a first transition metal layer and a second transition metal layer corresponding to opposite outer layers among the transition metal layers have different compositions so that the MXene has an asymmetrical out-of-plane-ordered structure.

9. The MXene of claim 8, wherein the MXene has the 312 phase.

10. The MXene of claim 8, wherein M includes at least three elements,
an element with a highest content in the first transition metal layer is an element with a highest atomic number among the elements of M, and
an element with a highest content in the second transition metal layer is an element with a lowest atomic number among the elements of M.

11. The MXene of claim 8, wherein the transition metal layers further include a third transition metal layer disposed between the first transition metal layer and the second transition metal layer,
M includes Ti, Zr, Hf, and Ta,
an element with a highest content in the first transition metal layer is Ti,
an element with a highest content in the second transition metal layer is Ta, and
an element with a highest content in the third transition metal layer is Hf.

12. The MXene of claim 8, wherein the transition metal layers further include a third transition metal layer disposed between the first transition metal layer and the second transition metal layer,
M includes Ti, Zr, Hf, and Ta,
Ti and Ta have a lowest content in the third transition metal layer, and
Zr and Hf have a lowest content in the second transition metal layer.

13. A method for manufacturing a MAX phase, the method comprising:
mixing and milling raw materials of an M component including at least two transition metal elements, an X component including nitrogen or carbon, and an A component including at least a first element and a second element, which are different from each other and selected from a Group 13 element, a Group 14 element, a Group 15 element, and a Group 16 element; and
forming the MAX phase having a layered structure of M₍ₙ₊₁₎AXₙ (where n is a natural number, and n and n+1 represent a number of layers) including a plurality of transition metal layers by pressurizing and sintering powder obtained through the milling,
wherein a difference in atomic radii of the first element and the second element is greater than or equal to 0.1 Å,
a first transition metal layer and a second transition metal layer corresponding to opposite outer layers among the transition metal layers have different compositions so that the MAX phase has an asymmetrical out-of-plane-ordered structure, and
a number of moles of the raw material of the A component is greater than or equal to a number of moles of the raw material of the M component.

14. The method of claim 13, wherein the first element of the A component is Al, and
the second element of the A component is Sn.

15. The method of claim 14, wherein n is 2, and
a raw material molar ratio of the M component and Al is 3:2.5 to 3:2.7.

16. The method of claim 15, wherein a raw material molar ratio of Al and Sn is 1:0.15 to 1:0.25, and
a molar ratio of Al and Sn in the MAX phase is 1.8:1 to 2.2:1.

17. The method of claim 13, wherein the MAX phase has the 312 phase.

18. The method of claim 14, wherein the M component includes Ti, Zr, Hf, and Ta.

19. The method of claim 14, wherein the milling is performed by using a zirconia ball.

20. A method for manufacturing a MXene, the method comprising:
manufacturing a MAX phase by a method according to claim 13; and
obtaining the MXene by removing an A component from the MAX phase.
